(19) United States
(12) Patent Application Publication
(10) Pub. No.: US 2007/0193437 A1
(43) Pub. Date: Aug. 23, 2007

(54) Apparatus, method, and medium retrieving a highlighted section of audio data using song lyrics

(75) Inventors: Dong-geon Kong, Yongin-si (KR); Hye-jeong Lee, Yongin-si (KR); Ji-hye Chung, Yongin-si (KR); Chang-kyu Choi, Yongin-si (KR); Yeun-bae Kim, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/699,341

(22) Filed: Jan. 30, 2007

(30) Foreign Application Priority Data
Feb. 7, 2006 (KR) 10-2006-0011824

(51) Int. Cl. G10H 1/36

(52) U.S. Cl. 84/610

(57) ABSTRACT

An apparatus, method, and medium for retrieving a highlighted section of audio data using song lyrics. The apparatus, method and medium allow a user to quickly retrieve and recognize desired music by setting a highlighted section of audio data using song lyrics to an audio file and playing the highlighted section during retrieval of the audio file. The method includes extracting title information and lyric information from metadata related to an audio file, checking whether a character string containing title information and a repeated character string exist based on the extracted title information and lyric information, when a character string containing title information and a repeated character string are found, storing the found character strings as highlight candidates, selecting one of the stored highlight candidates as a highlighted character string, and setting a highlighted section containing the selected highlighted character string.

### CROSS-REFERENCE TO RELATED APPLICATIONS

This application claims priority from Korean Patent Application No. 10-2006-0011824 filed on Feb. 7, 2006 in the Korean Intellectual Property Office, the disclosure of which is incorporated herein by reference in its entirety.

### BACKGROUND

1. Field

One or more embodiments of the present invention relate to an apparatus, method, and medium retrieving a highlighted section of audio data using song lyrics, and more particularly, to an apparatus, method, and medium retrieving a highlighted section of audio data using song lyrics, allowing a user to quickly recognize desired music by playing back the highlighted section while retrieving an audio file.

2. Description of the Related Art

Portable audio file players that can reproduce digitally encoded audio files are commonly used. That is, compact hand-held devices that can process digitally encoded audio files stored in semiconductor memories have become popular.

Further, as the demands for portable audio file players offering higher data storage capacities have increased, next-generation players containing compact, high capacity hard drives have been developed and are rapidly gaining popularity.

In an audio file player, data in a digital audio file is loaded into a data storage device by first downloading the data from an audio CD, the internet, or another digital audio device to a PC. Then, the data is typically compressed according to a selected encoding format and loaded into the data storage device for the audio file player.

The audio file is decompressed/decoded by the audio file player during playback according to the selected encoding format. Various encoding formats for compressing and decompressing audio files are available. Examples of encoding formats include, but are not limited to, MP3, MP3 Pro and Wave, for example.

For MP3 encoded audio files, a special set of frames called an ID3 tag are prefixed or appended to a data file. ID3 tags contain descriptive text and other data related to the audio file. For example, an ID3 tag may include title, artist, album, year, genre, and comments. ID3 tag information is useful for searching, sorting, and selecting a specific audio file based on the information contained in the ID3 tag. Because ID3 tag information is often stored as textual characters, the information can be displayed on the display screen of the audio file player.

With the advancement of technology, various independent devices are being integrated into single systems and the size of such devices is decreasing. In the wake of this trend, audio file players are being miniaturized and the size of display windows are decreasing. Thus, selecting a song title by manipulating small densely arranged buttons on the display window may cause considerable inconvenience to users.

Further, due to the increasing numbers of audio files being stored in audio file players, it is taking longer for users to retrieve desired audio files.

One approach to efficiently searching for a desired audio file is to use speech recognition for beginning index characters and a complete list of artist names and song titles. Another method is to use a music melody such as humming. Another method includes creating a fingerprint representing the characteristics of an audio file and providing an audio file having similar characteristics (singer/album/melody) to those of a song being currently played.

The above-mentioned approaches have a problem in that a user needs to perform searching depending on the classification and characteristics of audio files owned by him/her. The conventional methods also require users to remember complete information about the desired file while not providing partial search and associative search features.

Another drawback is that because the desired audio file has to be played from the beginning portion (i.e., prelude) of the file for confirmation, it may take a long time to recognize the audio file being played.

Japanese Laid-open Patent Application 2004-258659 proposes a method for extracting a highlighted section from a sports event audio signal. The method includes extracting a feature set from sports event audio data, classifying the feature set according to class, clap, applause, stroke, music, and speech with music, grouping adjacent features belonging to the same class, and selecting a portion of the audio signal corresponding to a group of features classified as clap or applause as a highlighted section. However, the method does not provide a technique for extracting a highlighted section from music content.

### SUMMARY

An aspect of one or more embodiments of the present invention includes an apparatus, method, and medium retrieving a highlighted section using song lyrics that can reduce the amount of time required for a user to select a desired song by setting the highlighted section based on song lyrics to an audio file and playing the highlighted section during retrieval of the audio file.

Another aspect of one or more embodiments of the present invention also includes an apparatus, method, and medium retrieving a highlighted section using song lyrics that can reduce retrieval time by searching for the highlighted section on a character string basis.

Another aspect of one or more embodiments of the present invention also includes an apparatus, method, and medium retrieving a highlighted section using song lyrics, which make it easier to retrieve desired music from a portable device by more quickly setting the highlighted section based on title information and lyric information contained in an audio file.

Additional aspects and/or advantages of the invention will be set forth in part in the description which follows and, in part, will be apparent from the description, or may be learned by practice of the invention.

According to an aspect of the present invention, an apparatus for retrieving a highlighted section using song lyrics is provided. The apparatus includes a title/lyric extractor to extract title information and lyric information from an audio file, a character string comparator to check whether a character string containing the title information and a repeated character string exist based on the extracted title information and lyric information, and a highlight selector to select one highlighted character string among the character strings found by the character string comparator and to set a highlighted section containing the selected highlighted character string.

According to another aspect of the present invention, a method for retrieving a highlighted section using song lyrics is provided. The method includes extracting title information and lyric information from metadata related to an audio file, checking whether a character string containing title information and a repeated character string exist based on the extracted title information and lyric information, when a character string containing title information and a repeated character string are found, storing the found character strings as highlight candidates, selecting one of the stored highlight candidates as a highlighted character string, and setting a highlighted section containing the selected highlighted character string.

According to another aspect of the present invention, an apparatus for retrieving a highlighted section of audio data using song lyrics is provided. The apparatus includes a title/lyric extractor to extract lyric information from text metadata relating to an audio file, a character string comparator to determine whether one or more character strings exist within the extracted lyric information according to a pre-defined rule, a highlight selector to select a highlighted character string among the one or more character strings found by the character string comparator and to set a highlighted section containing one or more occurrences of the selected highlighted character string, and an audio data marker to mark the location of the one or more occurrences of the selected highlighted character string within the audio data.

According to another aspect of the present invention, a method for retrieving a highlighted section of audio data using song lyrics is provided. The method includes extracting lyric information from text metadata related to an audio file, determining whether one or more character strings exist within the extracted lyric information according to a pre-defined rule, selecting a highlighted character string among the one or more character strings found by the character string comparator, setting a highlighted section containing one or more occurrences of the selected highlighted character string, and marking a location within the audio data of the one or more occurrences of the selected highlighted character string within the audio data.

### BRIEF DESCRIPTION OF THE DRAWINGS

These and/or other aspects and advantages of the present invention will become apparent and more readily appreciated from the following description of one or more exemplary embodiments taken in conjunction with the accompanying drawings in which:

FIG. 1 illustrates an apparatus for retrieving a highlighted section using song lyrics, according to an embodiment of the present invention;

FIG. 2 illustrates an example of extracting the title and lyrics of an audio file, according to an embodiment of the present invention;

FIGS. 3A and 3B illustrate examples of retrieving a repeated section of song lyrics, according to an embodiment of the present invention;

FIGS. 4A and 4B illustrate an example of setting a highlighted character string and highlighted section, according to an embodiment of the present invention; and

FIGS. 5A, 5B and 5C is illustrate a method for retrieving a highlighted section using song lyrics, according to an embodiment of the present invention.

### DETAILED DESCRIPTION OF EMBODIMENTS

One or more embodiments of the present invention will now be described in detail with reference to the accompanying drawings. Advantages and features of the present invention and methods of accomplishing the same may be understood more readily by reference to the following detailed description of embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art. Like reference numerals refer to like elements throughout the specification.

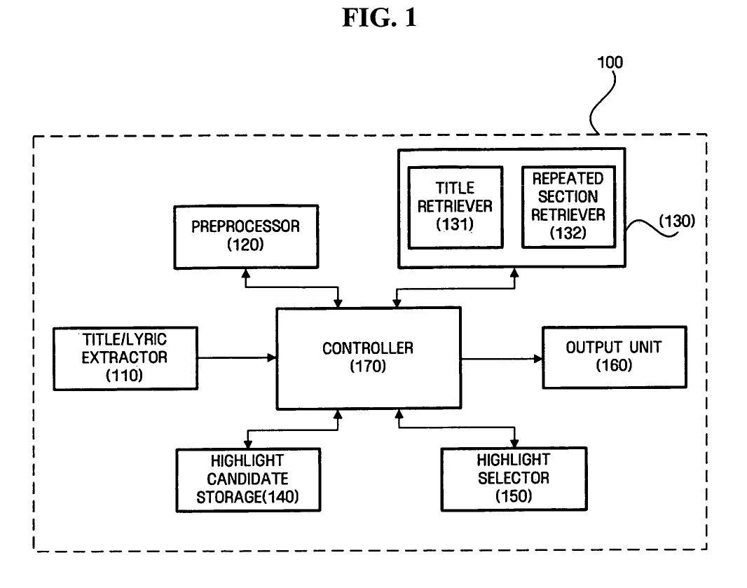

FIG. 1 illustrates an apparatus retrieving a highlighted section of audio data using song lyrics, according to an embodiment of the present invention.

Referring to FIG. 1, an apparatus for retrieving a highlighted section of audio data using song lyrics may include a title/lyric extractor 110, a preprocessor 120, a character string comparator 130, a highlight candidate storage 140, a highlight selector 150, an output unit 160, and a controller 170, for example. In one embodiment, it will be assumed that the apparatus for retrieving a highlighted section is a portable terminal 100. Here, as an example, the portable terminal 100 may be a mobile phone, a Personal Digital Assistant(PAD), or an MPEG Audio Layer-3 (MP3), or any portable music player.

The title/lyric extractor 110 may extract metadata (e.g., title information and lyric information) from an audio file. For example, the title/lyric extractor 110 may extract title information and lyric information from metadata stored in the form of a version 2 ID3 (ID3v2) tag or a watermark, noting that alternative embodiments are equally available.

The preprocessor 120 may delete supplementary text contained in the title information and lyric information extracted by the title/lyric extractor 110. Here, as only an example, such supplementary text may contain singer, album, genre, and special characters (i.e., -, _, < >, and . . . ).

For example, when the title information contains supplementary text (e.g., singer, album, and special characters) of ‘Magic castle—the Classic’, ‘Magic castle_album 1 _the Classic’, or ‘Magic castle (the Classic)’, the preprocessor 120 may delete the supplementary text and transmit only the title information to the character string comparator 130.

That is, when the title is followed by parenthesis ‘( ) ’, the preprocessor 120 may delete the parenthesis ‘( ) ’ and content enclosed in the parenthesis ‘( ) ’. When the title is followed by ‘-/_’, the preprocessor 120 may delete characters preceded by ‘-/_’.

When the lyric information contains supplementary information such as special characters, the preprocessor 120 may also delete the supplementary information and transmit only the lyric information to the character string comparator 130.

The character string comparator 130 may thus check whether a character string containing title information or a repeated character string exists in the lyric information, based on the title information and lyric information extracted by the title/lyric extractor 110. The character string comparator 130 may search text data for a character string containing the title information and a repeated character string on a string-by-string basis by comparing a plurality of alphabet characters in a predetermined character string with those in another character string and checking whether there is a character string with alphabet characters that are the same as or similar to those in the predetermined character string. When a character string having the same or similar alphabet characters does not exist, the character string comparator 130 may further subdivide the character string into a predetermined number of sub-strings for comparison. Each sub-string contains one or more alphabet characters.

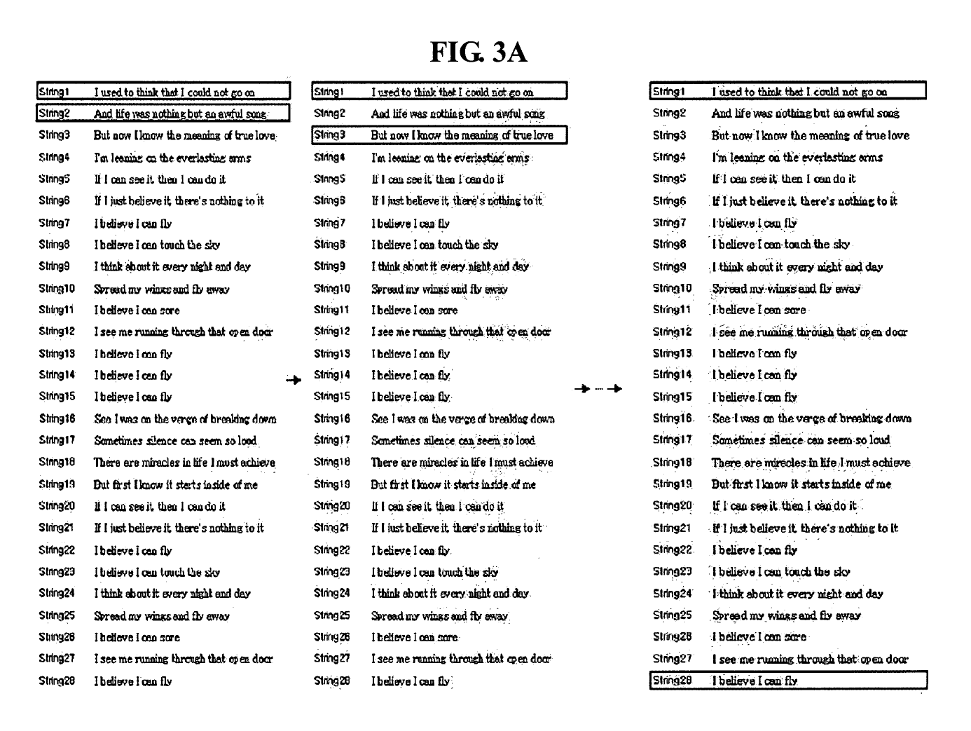

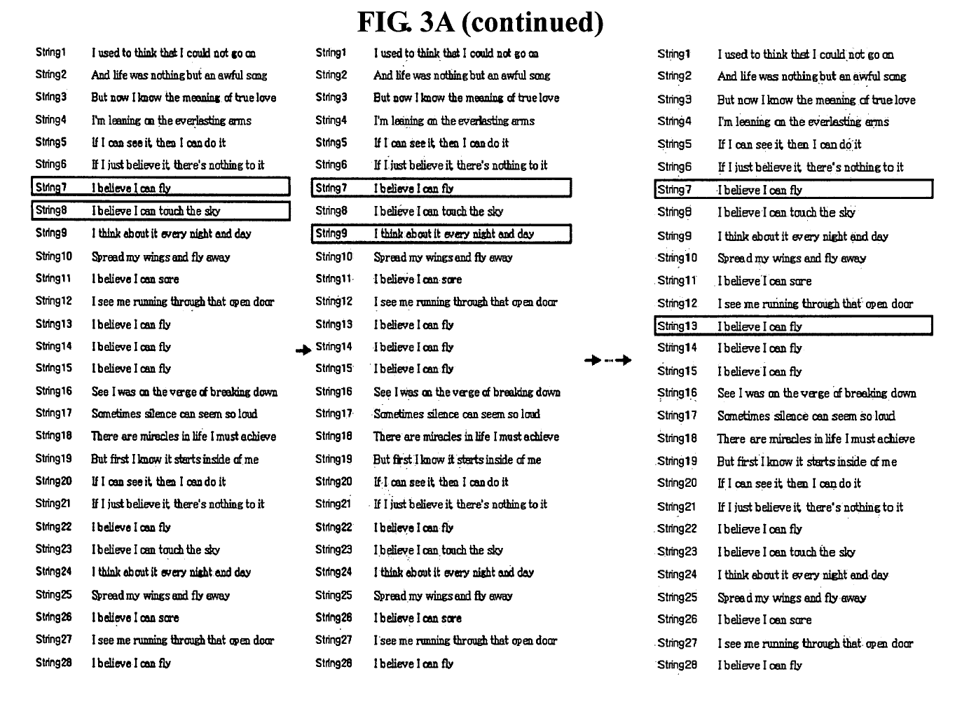

The character string comparator 130 may include a title retriever 131 and a repeated section retriever 132, for example. FIG. 3A illustrates an example of retrieving a repeated character string contained in song lyrics text.

The title retriever 131 checks whether a character string containing title information exists in lyric information by comparing the title information and lyric information extracted by the title/lyric extractor 110. The character string retrieved by the title retriever 131 may then be stored as a highlight candidate.

For example, when the title information about an audio file is ‘Magic castle’, the title retriever 131 checks whether a character string containing alphabet characters ‘Magic castle’ exists, on a character string basis. When a character string containing the title information (i.e., ‘Magic castle’) exists, the found character string is stored as a highlight candidate.

The repeated section retriever 132 checks whether a repeated character string exists in the lyric information extracted by the title/lyric extractor 110. Because two lines (two character strings) of lyrics are provided at a time, the repeated section retriever 132 searches for a repeated section on a character string basis. The character string found by the repeated section retriever 132 is stored as a highlight candidate.

For example, when no repeated section exists within each character string, the repeated section retriever 132 subdivides a character string into a predetermined number of sub-strings to create new character strings and checks whether a repeated section is present within each new character string. Below, an example of retrieving a repeated section for each newly created character string will be described in greater detail with reference to FIG. 3B.

Continuing this example, when character string 1 contains a plurality of alphabet characters ‘Beyond the magic castle and sinking sand’, the repeated section retriever 132 divides the character string 1 into a plurality of sub-strings (e.g., character strings 1a and 1b) based on the word-spacing. In this case, the character string 1 may be segmented into a plurality of sub-strings having an almost equal number of alphabet characters. For example, the character strings 1a and 1b may contain ‘Beyond the magic castle’ and ‘and sinking sand’, respectively.

The highlight candidate storage 140 stores character strings found by the character string comparator 130. The character strings are a character string containing title information and a repeated character string. The character strings are potentially a most essential portion of an audio file (hereinafter called ‘highlight character strings’).

The highlight candidate storage 140 may then store highlight character strings found by the character string comparator 130, for example, by type.

As an example, the highlight candidate storage 140 may store in separate tables a character string containing title information and a repeated character string, which are respectively retrieved by the title retriever 131 and the repeated section retriever 132.

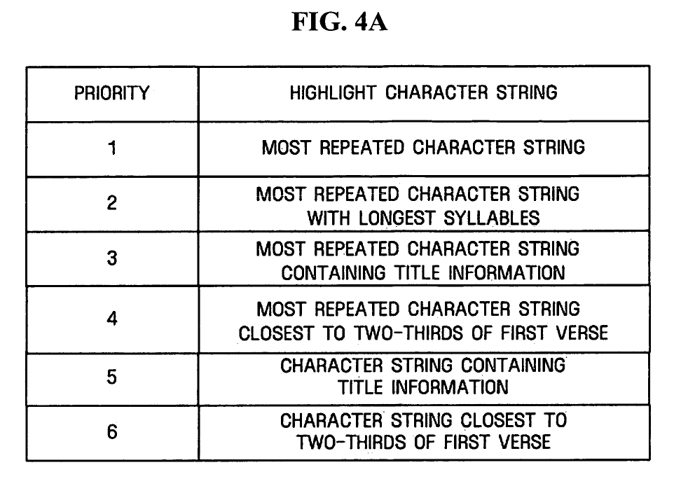

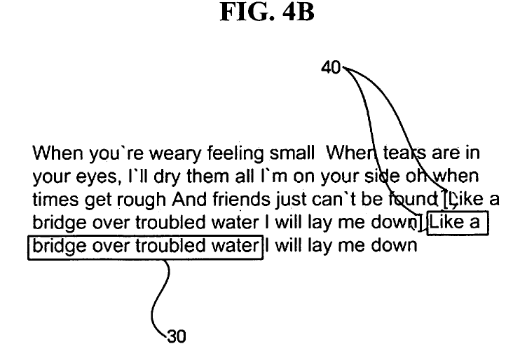

The highlight selector 150 may further determine the order of priority of candidate character strings, for example, stored in the highlight candidate storage 140, and select one of the candidate character strings as a highlighted character string. An example of selecting a highlighted character string will be described in greater detail below with reference to FIGS. 4A and 4B.

Referring to FIG. 4A, the highlight selector 150 determines the priority of candidate character strings in the order of a most frequently repeated character string, a most frequently repeated character string having the longest alphabet characters, a most frequently repeated character string containing title information, and a character string containing title information. The highlight selector 150 then selects one of the candidate character strings as a final highlighted character string.

The highlight selector 150 also sets a highlighted section based on the selected highlighted character string. The highlighted section is a section containing the highlighted character string, which is usually located in the middle of the highlighted character string. Alternatively, the highlighted character string may be located at the beginning of the highlighted section. An example of setting a highlighted section will be described below in more detail with reference to FIG. 4A-4B.

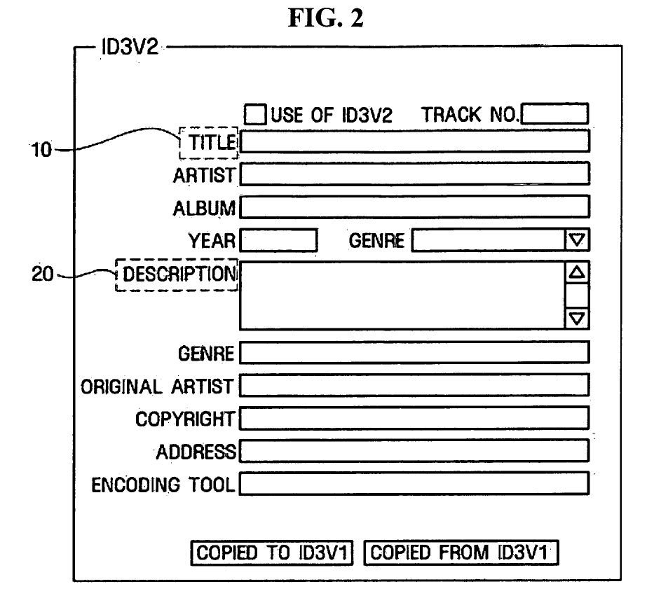

Markers are used to correlate lyrics text found in the ID3 v2 text metadata with corresponding MP3 audio data. For example, the MP3 audio file corresponding to the lyrics of FIG. 3A may total four minutes and ten seconds (4:10) of audio data. The markers may be created and stored as metadata, for example in the Description field 20 of FIG. 2. Each marker can be used to correlate a given lyrical string with its corresponding time in the MP3 audio file. For example, referring again to FIG. 3A, String 1, “I used to think that I could not go on,” may begin at time 0:20/4:10. String 2, “and life was nothing but an awful song,” may begin at time 0:28/4:10. Finally, String 28, “I believe I can fly,” may begin at 3:59/4:10. Each String (1-28) is thus marked with a marker so that its location within the MP3 audio file may be quickly accessed. The markers may be located by manually listening to MP3 audio and marking the appropriate time, or through automated procedures, as known by one skilled in the art.

The output unit 160 outputs audio data, corresponding to lyrics found in the highlighted section, through a speaker or earphones. In one embodiment, controller 170 may control the operation of all other components (110 through 160).

The controller 170 may also control the highlight candidate storage 140 to store the highlighted character strings received from the character string comparator 130, by type, for example.

FIG. 2 illustrates an example of extracting title and lyrics of an audio file, such as in the title/lyric extractor 110 of the apparatus 100, for retrieving a highlighted section of audio data using song lyrics according to a modified embodiment of the present invention. In this embodiment, the title and lyrics are extracted from an ID3 v2 tag having text data.

Referring to FIG. 2, the ID3 tag includes song title 10, artist, album name, year, genre, description 20, and other information. The ID3 tag information is useful for searching, sorting, and selecting a specific audio file based on the information contained in the ID3 tag. The description item 20 in the ID2 tag contains lyric information about the audio file, optionally including markers showing the location of the lyrics within the audio data.

For example, the title/lyric extractor 110 detects the song title item 10 and the description item 20 among the information contained in the version 2 ID3 tag, extracts title information and lyric information about an audio file from the song title item 10 and the description item 20, and transmits the extracted title information and lyric information to the preprocessor 120.

FIGS. 3A and 3B illustrate examples of retrieving a repeated section of song lyrics in the character string comparator 130 of the apparatus 100 for retrieving a highlighted section using song lyrics, according to an embodiment of the present invention.

Referring to FIG. 3A, the repeated section retriever 132 of the character string comparator 130 compares predetermined character strings representing lyric information with one another.

For example, the repeated section retriever 132 may determine the similarity between character strings based on a distance between the character strings. Distance, as used herein in a non-limiting example only, may refer to a degree of similarity between two strings based on the number of alphabet characters the strings share in common. Distance may be expressed as a percentage with 0% indicating no similarity between two strings and 100% indicating the strings are identical, for example. The distance between character strings can be measured by comparing each of a plurality of alphabet characters within a character string with each of a plurality of alphabet characters within another character string.

More specifically in this example, character string 1 contains a plurality of alphabet characters ‘I used to think that I could not go on’ and character string 2 contains a plurality of alphabet characters ‘And life was nothing but an awful song’.

The repeated section retriever 132 compares character string 2 with character string 1. Because character string 2 does not contain any alphabet characters that are the same as those within character string 1, the distance between character strings 1 and 2 is 0%.

Then, the repeated section retriever 132 compares character string 3 ‘But now I know the meaning of true love’ with character string 1 ‘I used to think that I could not go on’. Because character string 3 does not contain any matching alphabet characters that are the same as those in character string 1, the distance between character strings 1 and 3 is 0%.

The repeated section retriever 132 then compares character string 1 with each of character strings 4 through 28. When a character string having a distance greater than 80% with respect to character string 1 is found, the character string is determined to be the same character string as character string 1, i.e., a repeated character string, and is stored as a highlight candidate.

Next, the repeated section retriever 132 compares the character string 2 with each of character strings 3 through 28 and then compares the character string 3 with each of character strings 4 through 28. That is, the repeated section retriever 132 compares each character string with all other character strings.

Thereafter, the repeated section retriever 132 compares character string 7 with character string 8. Because character string 8 contains the same alphabet characters as those in character string 7 except for a word ‘fly’, the distance between the character strings 7 and 8 is 80% so character string 7 is stored as a highlight candidate.

The repeated section retriever 132 then determines the distance between character strings 7 and 9. Because character string 9 contains only a word ‘I’ that is the same as those in character string 7, the distance between the character strings 7 and 9 is 20%.

Similarly, when character string 20 is compared with character string 7, the distance there-between is 100% because character string 13 contains the same alphabet characters as those in character string 7. Thus, either character string 7, or 10, is stored as a highlight candidate.

Thus, the repeated section retriever 132 may determine, for example, a character string having a distance greater than 80% with respect to a specific character string to be the same character string as the specific character string (i.e., a repeated character string). The character string may then be stored as a highlight candidate.

Referring to FIG. 3B, when no highlight candidate is found through the process illustrated in FIG. 3A, the repeated section retriever 132 may further divide character string 1 into a plurality of sub-strings (e.g., character strings 1a and 1b) based on the word-spacing to create new character strings. In this case, each of the new character strings may contain an almost equal number of alphabet characters.

That is, the repeated section retriever 132, may group a plurality of alphabet characters within character string 1 into a predetermined number of sub-strings to create new character strings (e.g., character strings 1a and 1b).

As illustrated in FIG. 3B, character string 1a includes a plurality of alphabet characters ‘I used to think ’ and character string 1b includes a plurality of alphabet characters ‘that I could not go on’. Character string 2a contains ‘And life was nothing’ and character string 2b contains ‘but an awful song’.

First, with this example, the repeated section retriever 132 may compare character string 1a with character string 2a to check the distance there-between. Because character string 2a does not contain any alphabet characters that are the same as those in character string 1a, the distance between character strings 1a and 2a is 0%.

The repeated section retriever 132 then compares character string 2b with character string 1a to check the distance there-between. Because character string 2b does not contain any alphabet characters that are the same as those in character string 1a, the distance between character strings 1a and 2b is 0%.

Next, the repeated section retriever 132 compares character string 1a with each of character strings 3a through 1b and then compares character string 1b with each of character strings 2a through 11b. That is, the repeated section retriever 132 compares each character string with all other character strings.

Meanwhile, when the repeated section retriever 132 fails to find a highlight candidate through the process illustrated in FIG. 3B, it may divide a new character string again into yet smaller units in order to retrieve a highlight candidate.

FIGS. 4A and 4B illustrate an example of setting a highlighted character string and a highlighted section in an apparatus for retrieving a highlighted section of audio data using song lyrics, according to an embodiment of the present invention. FIG. 4A is a table illustrating the order of priority for selecting a final highlighted character string and FIG. 4B illustrates an example of setting a highlighted section containing a final highlighted character string.

The highlight selector 150 may select a final highlighted character string among the character strings stored in the highlight candidate storage 140 as highlight candidates according to the order of priority illustrated in the table of FIG. 4A.

For example, the most frequently repeated character string, and the most frequently repeated character string having the longest alphabet characters may have the first and second highest priorities. The most frequently repeated character string containing title information, and the most frequently repeated character string closest to a point corresponding to two-thirds of the lyrics of the first verse may have the third and fourth highest priorities. A character string containing title information may have fifth highest priority. The foregoing are only used for exemplary purposes and thus other rules and order of priority are equally available and may also be selected by a user.

As shown in FIG. 4A, when a highlighted character string is not stored in the highlight candidate storage 140 according to the above rules having priorities 1-5, the highlight selector 150 selects a character string closest to a point corresponding to two-thirds of the lyrics of the first verse as a highlighted character string. In this case, the character string has the sixth highest priority. By using metadata related to an audio file, which contains lyric information and time information indicating the beginning of each character string, the point corresponding to the two-thirds of the lyrics of the first verse can be easily found in the audio data.

Referring to FIG. 4B, a final highlighted character string (e.g., a character string containing the alphabet characters ‘Like a bridge over troubled water’) 30 is indicated in lyric information related to a predetermined audio file.

For example, the highlight selector 150 may check the position of the highlighted character string 30 and set a highlighted section 40 surrounding the checked position.

That is to say, as illustrated in FIG. 4B, the highlight selector 150 may set a highlighted section 40 that contains the highlighted character string 30 at the beginning thereof. Alternatively, the highlight sector 150 may set a highlighted section 40 that contains the highlighted character string 30 in the middle thereof. As discussed previously, markers are used to correlate the text of the highlighted section 40 with corresponding MP3 audio data. On each occasion that the highlighted character string 30 occurs in the text metadata, its corresponding location is found in the audio data using the closest marker in time to the beginning of the highlighted character string 30.

Thereafter, the audio data corresponding to the text of the highlighted section 40 is output through the output unit 160 during retrieval of the audio file. This provides a user with highlights of the song making it easier to recognize the song without having to listen to the song in its entirety.

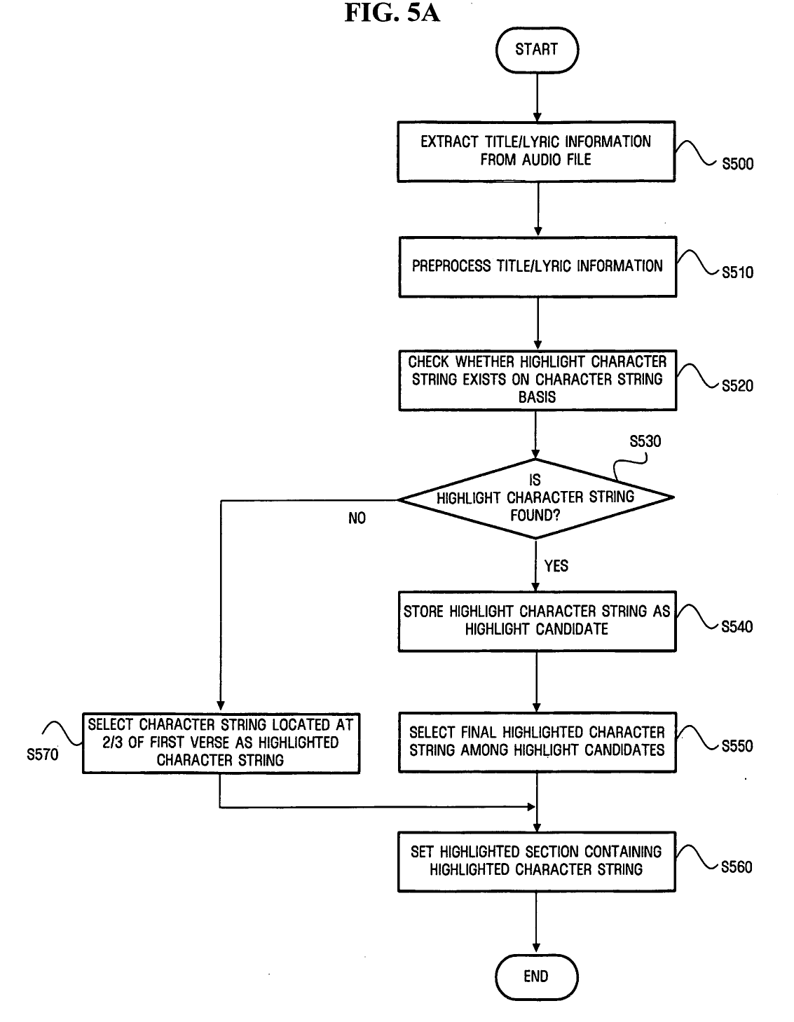

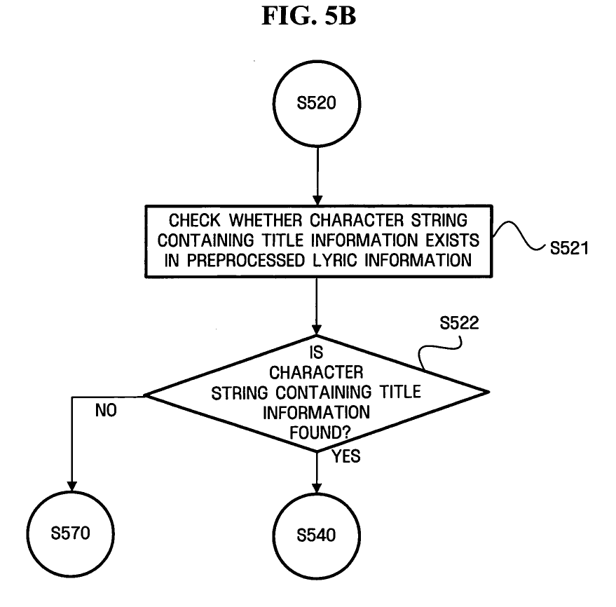

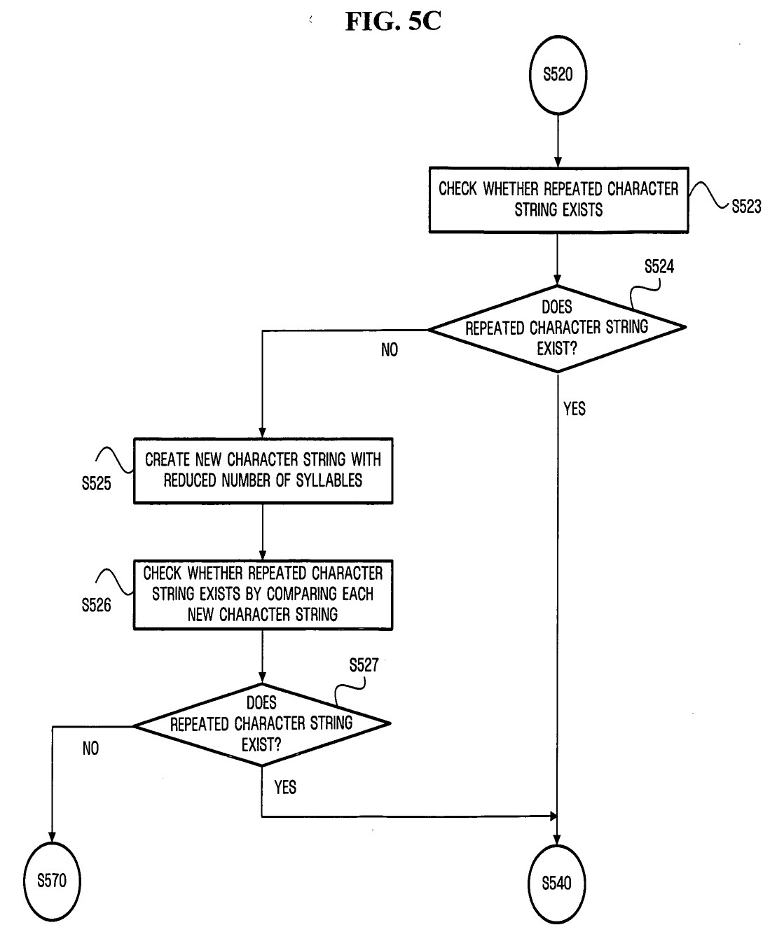

FIGS. 5A-5C illustrate a method for retrieving a highlighted section of audio data using song lyrics, according to one or more embodiments of the present invention. FIG. 5A illustrates the entire process of retrieving a highlighted section using song lyrics, FIG. 5B illustrates a retrieving of a character string containing a title, such as in the process of FIG. 5A, and FIG. 5C illustrates a retrieving of a repeated character string, such as in the process of FIG. 5A. The method for retrieving a highlighted section using song lyrics, according to an embodiment of the present invention, will now be described with greater detail with reference to FIGS. 1 and 5A-5C.

Title information and lyric information may be extracted from metadata related to an audio file, for example, by title/lyric extractor 110, in operation S500. The metadata is typically text information stored in a version 2 ID3 tag or a watermark, for example.

The received title information and lyric information may be preprocessed by deleting supplementary text information (e.g., artist name and special characters) contained in the title information and lyric information, for example, by preprocessing 120, in operation S510.

It may further be determined whether a character string containing title information and a repeated character string exist based on the preprocessed title information and lyric information, for example, by character string comparator 130, in operation S520. The character string containing title information and the repeated character string can be understood as a highlighted portion of the audio file (hereinafter called a ‘highlight character string’). The process of retrieving a character string containing title information and the repeated character string will be described later in more detail below with reference to FIGS. 5B and 5C.

When one or more highlight character strings exist, i.e., character strings containing title information and/or a repeated character string exist, exist the highlight character strings may be stored, for example, in the highlight candidate storage 140, in operation S540. In this case, for example, the highlight character strings (the character string containing title information and/or the repeated character string) may be stored separately, by type.

A final highlighted character string among the highlight character strings, for example, stored in the highlight candidate storage 140, may then be selected, for example, by the highlight selector 150, in operation S550. In this case, the order of priority for selection may be determined as follows: the most frequently repeated character string, a most frequently repeated character string having the longest alphabet characters, a most frequently repeated character string containing title information, and a character string containing title information, as detailed in FIG. 4A.

A highlighted section of audio data that contains the selected highlighted character string in the middle thereof may then be set, for example, by highlight selector 150, in operation S550. Markers are used to correlate the MP3 audio data with the corresponding text of the highlighted character string. On each occasion that the highlighted character string occurs in the text metadata, its corresponding location is found in the audio data using the closest marker in time to the beginning of the highlighted character string 30.

Conversely, when the highlight character strings (a character string containing title information and a repeated character string) do not exist a character string closest to a point corresponding to two-thirds of the lyrics of the first verse may be selected as a highlighted character string in operation S570.

Thereafter, when the audio file is selected by a user, the controller 170 controls the output unit 160 to output the audio data corresponding to the text of the highlighted section, may be output, for example, as controlled by controller 170.

Thus, a method for retrieving a highlighted section using song lyrics according to one or more embodiments of the present invention allows a user to quickly retrieve and recognize desired music by retrieving a highlighted section of audio data using song lyrics found in metadata to the audio file. The user may then play the highlighted section of audio data during retrieval of the audio file. This allows the user to recognize the song without having to listen to the song in its entirety.

Retrieving a character string containing a title in the method of FIG. 5A will now be described in more detail with reference to FIG. 5B.

Referring to FIG. 5B, in operation S521, the character string comparator 130 may check whether a character string containing title information exists on a string-by-string basis, for example.

When the character string containing title information exists in operation S522, the character string comparator 130 may transmit the character string to the highlight candidate storage 140 in S540. Conversely, when the character string containing the title information does not exist, the method may proceed to operation S570.

An example of retrieving a repeated character string in the method of FIG. 5A will now be described in more detail with reference to FIG. 5C.

Referring to FIG. 5C, in operation S523, the character string comparator 130 may check whether a repeated character string exists in the preprocessed lyric information on a string-by-string basis. When the repeated character string exists in operation S524, the character string comparator 130 may transmit the character string to the highlight candidate storage 140 in S540.

Conversely, when the repeated character string does not exist in operation S524, the character string comparator 130 may partition each character string into a plurality of sub-strings according to the word-spacing and create new character strings in operation S525. Each of the new character strings may contain an almost equal number of alphabet characters, as an example.

After creating new character strings, the character string comparator 130 may check whether a repeated character string exists in operation S526. When the repeated character string exists in operation S527, the method may proceed to operation S540. Conversely, when the repeated character string does not exist in operation S527, the method may proceed to operation S570.

Retrieving a character string containing title information, as illustrated in FIG. 5B, may optionally be omitted.

In addition to this discussion, embodiments of the present invention can also be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code can be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media such as carrier waves, as well as through the Internet, for example. Here, the medium may further be a signal, such as a resultant signal or bitstream, according to embodiments of the present invention. The media may also be a distributed network, so that the computer readable code is stored/transferred and executed in a distributed fashion. Still further, as only a example, the processing element could include a processor or a computer processor, and processing elements may be distributed and/or included in a single device.

The apparatus, method, and medium retrieving a highlighted section using song lyrics according to the present invention have one or more of the following advantages.

The present invention can reduce the amount of time required for a user to select a desired song by setting a highlighted section of audio data based on song lyrics to an audio file and playing the highlighted section during retrieval of the audio file.

The present invention can also set a highlighted section more quickly by selecting a character string containing a title and a repeated character string as a highlighted character string based on title information and lyric information contained in an audio file, thus allowing the user to more easily retrieve desired music from a portable device.

While the present invention has been particularly shown and described with reference to embodiments thereof, it will be apparent to those skilled in the art that the scope of the invention is given by the appended claims, rather than the preceding description, and all variations and equivalents which fall within the range of the claims are intended to be embraced therein. Therefore, it should be understood that the above embodiments are not limitative, but illustrative in all aspects. For example, although one or more embodiments presented herein relate to highlighting music using lyrics, one skilled in the art will recognize that other types of audio data may be highlighted such as audio books, instruction manuals, courses, manuals, lectures and speeches.

Here, the term ‘unit’, ‘module’, or ‘component’, as used herein, is intended to mean, but is not limited to, a software or hardware component, such as a Field Programmable Gate Array (FPGA) or Application Specific Integrated Circuit (ASIC), which performs certain tasks. A unit may advantageously be configured to reside on the addressable storage medium and configured to execute on one or more processors. Thus, a unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a communication system.

What is claimed is:

1. An apparatus retrieving a highlighted section using song lyrics, the apparatus comprising:
a title/lyric extractor to extract title information and lyric information from an audio file;
a character string comparator to check whether a character string containing title information and a repeated character string exist based on the extracted title information and lyric information; and
a highlight selector to select one highlighted character string among the strings found by the character string comparator and to set a highlighted section containing the selected highlighted character string.

2. The apparatus of claim 1, wherein the character string comparator comprises:
a title retriever to compare the title information and lyric information and to check whether a character string containing title information exists in the lyric information on a character string basis; and
a repeated section retriever to check whether a repeated character string exists in the extracted lyric information on a character string basis;

3. The apparatus of claim 1, wherein the highlight selector determines a priority of the found character strings in an order of a most frequently repeated character string, a most frequently repeated character string having longest alphabet characters, a most frequently repeated character string containing title information, and a character string containing title information and selecting a highlighted character string according to the determined order of priority.

4. The apparatus of claim 1, further comprising:
a preprocessor to delete supplementary information contained in the extracted title information and the lyric information; and
a highlight candidate storage to store a highlight character string obtained by the character string comparator.

5. A method for retrieving a highlighted section using song lyrics, the method comprising:
extracting title information and lyric information from metadata related to an audio file;
checking whether a character string containing title information and a repeated character string exist based on the extracted title information and lyric information;
when a character string containing title information and a repeated character string are found, storing the found character strings as highlight candidates;
selecting one of the stored highlight candidates as a highlighted character string; and
setting a highlighted section containing the selected highlighted character string.

6. The method of claim 5, further comprising preprocessing the extracted title information and the lyric information.

7. The method of claim 5, wherein the storing of the found character strings as highlight candidates further comprises:
comparing the title information and lyric information and checking whether a character string containing title information exists in the lyric information on a character string basis; and
when the character string containing title information does not exist, storing a character string located at a point corresponding to two-thirds of the first verse of the lyric information as a highlight candidate.

8. The method of claim 5, wherein the storing of the found character strings as highlight candidates further comprises:
checking whether a repeated character string exists in the lyric information on a character string basis; and
when the repeated character string does not exist, storing a character string located at a point corresponding to two-thirds of the first verse of the lyric information as a highlight candidate

9. The method of claim 8, further comprising:
when the repeated character string does not exist, dividing the character string into a predetermined number of new character strings; and
checking whether a repeated character string exists by comparing alphabet characters in each of the new character strings.

10. The method of claim 5, wherein in the selecting of one of the stored highlight candidates as a highlighted character string, the priority of the found character strings is determined in order of a most frequently repeated character string, a most frequently repeated character string having the longest alphabet characters, a most frequently repeated character string containing title information, and a character string containing title information, and a highlighted character string is selected according to the determined order of priority.

11. At least one medium comprising computer readable code to control at least one processing element to implement the method of claim 5.

12. An apparatus for retrieving a highlighted section of audio data using song lyrics, the apparatus comprising:
a title/lyric extractor to extract lyric information from text metadata relating to an audio file;
a character string comparator to determine whether one or more character strings exist within the extracted lyric information, according to a pre-defined rule;
a highlight selector to select a highlighted character string among the one or more character strings found by the character string comparator and to set a highlighted section containing one or more occurrences of the selected highlighted character string; and
an audio data marker to mark the location of the one or more occurrences of the selected highlighted character string within the audio data.

13. The apparatus of claim 12, further comprising an audio output unit to output the marked audio data corresponding to the lyric information in the highlighted section.

14. A method for retrieving a highlighted section of audio data using song lyrics, the method comprising:
extracting lyric information from text metadata related to an audio file;
determining whether one or more character strings exist within the extracted lyric information according to a pre-defined rule;
selecting a highlighted character string among the one or more character strings determined to exist within the extracted lyric information;
setting a highlighted section containing one or more occurrences of the selected highlighted character string; and
marking a location within the audio data of the one or more occurrences of the selected highlighted character string.

15. The method of claim 14, further comprising outputting the audio data corresponding to the lyric information in the highlighted section according to the location marked within the audio data.
